(19) United States
(12) Patent Application Publication
(10) Pub. No.: US 2006/0088693 A1
(43) Pub. Date: Apr. 27, 2006

(54) Blends of ethylene-alpha-olefin-diene polymers and ethylene-alpha-olefin polymers for wire and cable applications

(76) Inventors: George James Pehlert, Houston, TX (US); Narayanaswami Raja Dharmarajan, Houston, TX (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 10/973,975

(22) Filed: Oct. 25, 2004

(51) Int. Cl. B32B 27/32

(52) U.S. Cl. 428/141; 428/521; 428/523

(57) ABSTRACT

Electrical insulation compounds are disclosed, the insulation compounds including an ethylene alpha-olefin diene elastomeric polymer, an ethylene alpha-olefin polymer having a Melt Index Ratio I₁₀/I₂ of at least 5, and 20 phr of filler or less per 100 parts of polymer. Also disclosed are electrical devices including an electrically insulating portion, wherein the insulating portion is an extruded compound having low surface roughness at typical operating extrusion rates.

### FIELD OF THE INVENTION

The present invention is directed generally to compositions containing 20 phr or less of filler for electrical insulating applications, and particularly, but not exclusively to electrical wires and cables coated with such compositions. More particularly, the insulation compounds include an ethylene alpha-olefin diene elastomeric polymer, an ethylene alpha-olefin polymer having a Melt Index Ratio I₁₀/I₂ of at least 5, and no more than 20 phr of filler.

### BACKGROUND

A variety of polymeric materials have been utilized as electrical insulating materials for power cables and other electrical devices. Typical insulation compounds include elastomers such as ethylene-propylene polymers (EP) and ethylene-propylene-diene polymers (EPDM), collectively referred to herein as EP(D)M. These insulation compounds are applied as an insulation member over either a metallic conductor or a semi-conductive substrate in a multi-step extrusion process.

EP(D)M polymers used in electrical applications generally contain fillers within the range of from 40 to 100 parts per hundred parts by weight of polymer (phr) to achieve acceptable mechanical properties and extrusion processability. The addition of filler, however, increases power loss through the cable. In the power transmission and distribution industry, power loss is associated with cost debits. The cost associated with power loss is proportional to the voltage, and becomes a significant factor in medium voltage applications (5 to 69 kV) and even more significant in high voltage applications (>69 kV).

U.S. Pat. No. 6,270,856 discloses an electrical insulating layer which may contain unfilled or filled polymer comprising an ethylene-α-olefin polymer, optionally including a diene, and having a density of from about 0.86 to about 0.96 g/cm³, a melt index of from about 0.2 to about 100 dg/min, a molecular weight distribution of from about 1.5 to about 30, and a composition distribution breadth index greater than about 45%.

U.S. Pat. No. 5,246,783 discloses an electrical insulating member which may contain unfilled or filled polymer selected from the group consisting of ethylene polymerized with at least one comonomer selected from the group consisting of C3 to C20 α-olefins and C3 to C20 polyenes, and wherein the polymer has a density in the range of about 0.86 to about 0.96 g/cm³, a melt index in the range of about 0.2 to about 100 dg/min, a molecular weight distribution in the range of about 1.5 to about 20, and a composition distribution breadth index greater than about 45%.

PCT Publication WO 02/085954 discloses that power cable coating compounds can be prepared with high levels of ethylene α-olefin polymers blended with an ethylene α-olefin diene polymer, with proper selection of the ethylene α-olefin polymer. The exemplified compounds contain filler in various amounts.

An article entitled “EPDM-metallocene Plastomer Blends for Wire and Cable,” by George Pehlert, et al., in Rubber World, Vol. 226, No. 2, May 2002, describes blends containing as fillers Red lead, surface treated calcined clay, and zinc oxide.

A need exists for a polymeric insulation compound containing low levels of filler, while still having good mechanical properties, good dielectric properties, and good water treeing resistance, without sacrificing extrusion processability and extruded surface smoothness at relatively high extrusion rates.

### SUMMARY

It has been surprisingly found that insulation compounds for use in electrical devices can be prepared with high levels of ethylene alpha-olefin polymers blended with one or more EP(D)M polymers, and low levels of filler (from 0 to less than 20 phr), while still possessing good extrusion processability defined as smoothness of the extrudate at typical operating extrusion rates.

In another embodiment, the present invention provides an electrically conductive device including an electrically conductive portion and an electrically insulating portion. The insulating portion includes an electrical insulation compound which comprises at least 10 wt % of an ethylene alpha-olefin diene elastomeric polymer, at least 10 wt % of an ethylene alpha-olefin polymer having a Melt Index Ratio I₁₀/I₂ of at least 5, and 20 phr or less of filler. The combined weight of the ethylene alpha-olefin diene elastomeric polymer and the ethylene alpha-olefin polymer generally makes up at least 80 wt % of the insulation compound. In a particular aspect of this embodiment, the insulation compound has a 28 day dissipation factor of less than 0.01. In another particular aspect of this embodiment, the device is a medium voltage power cable.

Extruded compounds according to the present invention have good processability characteristics at high extrusion rate, characterized by a low surface roughness factor as defined herein. Thus, in one aspect, the present invention provides an electrically conductive device including an extruded coating compound having an extrusion profile measured from a sample extruded at 100 rpm and 125° C., the extrusion profile having a plurality of positive and negative vertical deviations from a mean extrudate surface line, wherein the extruded compound has a surface roughness factor R of less than 20, where R is defined by
R=Ra+0.1Rt,
Ra is the mean absolute vertical deviation from the mean extrudate surface line, and Rt is the absolute vertical difference between the maximum positive vertical deviation from the mean extrudate surface line and the maximum negative vertical deviation from the mean extrudate surface line.

### DETAILED DESCRIPTION

The term “power cable coating compound” or “compound” is used herein to mean a polymer component or components in combination with fillers, accelerants, curatives, extenders, and other additives well known in the art. Power cable coating compounds are described in more detail below.

The term “filler” is used herein to mean inorganic particulate fillers such as carbon black, lead, clay, calcined clay, silane treated calcined clay, talc, calcium carbonate, mica, silica, zinc oxides, titanium oxides, magnesium oxides, combinations thereof, and the like.

As used herein, the term “polymer” includes homopolymers, copolymers, interpolymers, terpolymers, etc. Polymer may also refer to one or more polymers regardless of the method, time, and apparatuses used to combine the polymers. Additionally, polymer may be used to refer to polymeric compositions.

Power cables generally include one or more metal conductors in a core that is surrounded by one or more polymeric layers. As used herein, the term “electrically conductive portion” refers to the metallic conductor portion of the power cable, and the term “electrically insulating portion” refers to the non-metallic, polymeric portion of the power cable, which may include one or more semi-conducting layer(s) and/or one or more insulating layer(s). Thus, in embodiments described herein including “an electrically insulating portion comprising an electrical insulation compound,” the insulation compound may be present in the any one or more of the non-metallic, polymeric layers of the electrical device.

Ethylene Alpha-Olefin Diene Elastomer

Embodiments of the present invention include an ethylene-alpha-olefin-diene elastomer. In one embodiment, the elastomer is a polymer of ethylene; an alpha olefin, such as propylene; and at least one non-conjugated diene. In a particular aspect of this embodiment, the elastomer is a polymer of ethylene, propylene, and vinyl norbornene. In another particular aspect of this embodiment, the elastomer is a polymer of ethylene, propylene, vinyl norbornene, and ethylidene norbornene. Non-conjugated dienes useful as co-monomers preferably are straight or branched chain hydrocarbon di-olefins or cycloalkenyl-substituted alkenes, having about 6 to about 15 carbon atoms, for example: (a) straight chain acyclic dienes, such as 1,4-hexadiene and 1,6-octadiene; (b) branched chain acyclic dienes, such as 5-methyl-1,4-hexadiene; 3,7-dimethyl-1,6-octadiene; and 3,7-dimethyl-1,7-octadiene; (c) single ring alicyclic dienes, such as 1,4-cyclohexadiene; 1,5-cyclo-octadiene and 1,7-cyclododecadiene; (d) multi-ring alicyclic fused and bridged ring dienes, such as tetrahydroindene; norbornadiene; methyl-tetrahydroindene; dicyclopentadiene (DCPD); bicyclo-(2.2.1)-hepta-2,5-diene; alkenyl, alkylidene, cycloalkenyl and cycloalkylidene norbornenes, such as 5-methylene-2-norbornene (MNB), 5-propenyl-2-norbornene, 5-isopropylidene-2-norbornene, 5-(4-cyclopentenyl)-2-norbornene, 5-cyclohexylidene-2-norbornene, and 5-vinyl-2-norbornene (VNB); (e) cycloalkenyl-substituted alkenes, such as vinyl cyclohexene, allyl cyclohexene, vinyl cyclooctene, 4-vinyl cyclohexene, allyl cyclodecene, and vinyl cyclododecene. Preferred non-conjugated dienes are 5-ethylidene-2-norbornene (ENB), 1,4-hexadiene, dicyclopentadiene (DCPD), norbornadiene, and 5-vinyl-2-norbornene (VNB), with VNB being most preferred. Note that throughout this application the terms “non-conjugated diene” and “diene” are used interchangeably.

In a particular embodiment, the non-conjugated diene is vinyl norbornene. Although not wishing to be bound by theory, the Ziegler polymerization of the pendent double bond in vinyl norbornene (VNB) is believed to produce a highly branched ethylene, alpha-olefin, vinyl norbornene elastomeric polymer. This method of branching permits the production of ethylene, alpha-olefin, vinyl norbornene elastomeric polymers substantially free of gel which would normally be associated with cationically branched ethylene, alpha-olefin, vinyl norbornene elastomeric polymers containing, for instance, a less-preferred non-conjugated diene such as 5-ethylidene-2-norbornene or 1,4-hexadiene. The synthesis of substantially gel-free ethylene, alpha-olefin, vinyl norbornene elastomeric polymers containing vinyl norbornene is discussed in Japanese laid open patent applications JP S61-151758 and JP S62-210169.

The elastomer can contain ethylene-derived units in a range from a lower limit of 50, or 60, or 65, or 68 mole percent to an upper limit of 80 or 85 or 90 mole percent, based on the total moles of monomer-derived units in the polymer. The elastomer can contain alpha-olefin-derived units in a range from a lower limit of 10, or 15, or 20 mole percent to an upper limit of 32, or 35, or 40, or 50 mole percent, based on the total moles of monomer-derived units in the polymer. The elastomer can contain non-conjugated diene-derived units in a range of from a lower limit of 0.1, or 0.16 mole percent to an upper limit of 0.4, or 1.5, or 5 mole percent, based on the total moles of monomer-derived units in the polymer.

The elastomer can also be characterized by a Mooney viscosity (ML [1+4] 125° C.) of from 10 to 80, and a molecular weight distribution Mw,GPC,LALLS/Mn,GPC,DRI (Mw/Mn) of greater than 6, or greater than 10.

In a particular embodiment, the procedure for preparing the elastomer is as follows. The catalysts used are VOCl₃ (vanadium oxytrichloride) or VCl₄ (vanadium tetrachloride). The co-catalyst is chosen from (i) ethyl aluminum sesqui chloride (SESQUI), (ii) diethyl aluminum chloride (DEAC), and (iii) equivalent mixture of diethyl aluminum chloride and triethyl aluminum (TEAL). As shown in FIG. 8 of U.S. Pat. No. 5,763,533, the choice of co-catalyst influences the composition distribution in the polymer. An elastomer with a broader composition distribution is expected to provide better tensile strength in a cable coating compound. The polymerization is carried out in a continuous stirred tank reactor at 20-65° C. at a residence time of 6-15 minutes and a pressure of 7 kg/cm2. The concentration ratio of vanadium to alkyl is from 1 to 4 to 1 to 8. About 0.3 to 1.5 kg of polymer is produced per gram of catalyst fed to the reactor. The polymer concentration in the hexane solvent is in the range of 3-7% by weight. As reported in U.S. Pat. No. 5,763,533, the synthesis of ethylene, alpha-olefin, vinyl norbornene polymers was conducted both in a laboratory pilot unit (output about 4 kg/day), a large scale semi works unit (output 1 T/day), and a commercial scale production unit (output 200,000 kg/day).

A discussion of catalysts suitable for polymerizing the elastomeric polymer or other catalysts and co-catalysts contemplated can be found in Japanese laid open patent applications JP S61-151758 and JP S62-210169.

The resulting polymers had the following molecular characteristics:

(i) the intrinsic viscosity measured in decalin at 135° C. was in the range of 1 to 2 dL/g;

(ii) the molecular weight distribution (Mw,LALLS/Mn,GPC/DRI) was greater than 10; and

(iii) the branching index was in the range of 0.1 to 0.3.

Metallocene catalysis to form the ethylene alpha-olefin diene polymer is also contemplated. Suitable metallocene compounds, activators, and processes are well known in the art and can be found in U.S. Pat. No. 5,763,533 and references cited therein.

For peroxide cure applications, ethylene, alpha-olefin, diene monomer elastomeric polymers wherein the diene monomer is vinyl norbornene require lower levels of peroxide to attain the same cure state, compared to analogous polymers wherein the diene monomer is ethylidene norbornene, at the same level of incorporated diene. Typically, 20 to 40% lower peroxide consumption can be realized using ethylene, alpha-olefin, vinyl norbornene. The efficiency of vinyl norbornene in providing high crosslink density with peroxide vulcanization also permits a reduction in the overall diene level to attain the same cure state as with ethylidene norbornene polymers, and results in enhanced heat aging performance. The unique combinations of improved processability, lower peroxide usage and enhanced heat aging are particular advantages provided by ethylene, alpha-olefin, vinyl norbornene polymers over less preferred polymers containing non-conjugated dienes such as ethylidene norbornene or 1-4, hexadiene.

Molecular weight distribution (MWD) is a measure of the range of molecular weights within a given polymer sample. It is well known that the breadth of the MWD can be characterized by the ratios of various molecular weight averages, such as the ratio of the weight average molecular weight to the number average molecular weight, Mw/Mn, or the ratio of the Z-average molecular weight to the weight average molecular weight, Mz/Mw.

Mz, Mw and Mn can be measured using gel permeation chromatography (GPC), also known as size exclusion chromatography (SEC). This technique utilizes an instrument containing columns packed with porous beads, an elution solvent, and detector in order to separate polymer molecules of different sizes. In a typical measurement, the GPC instrument used is a Waters chromatograph equipped with ultrastyro gel columns operated at 145° C. The elution solvent used is trichlorobenzene. The columns are calibrated using sixteen polystyrene standards of precisely known molecular weights. A correlation of polystyrene retention volume obtained from the standards, to the retention volume of the polymer tested yields the polymer molecular weight.

Average molecular weights M can be computed from the expression:

$$M = \frac{{\sum }_{i} {N}_{i} {M}_{i}^{n + 1}}{{\sum }_{i} {N}_{i} {M}_{i}^{n}}$$

where Nᵢ is the number of molecules having a molecular weight Mᵢ. When n=0, M is the number average molecular weight Mn. When n=1, M is the weight average molecular weight Mw. When n=2, M is the Z-average molecular weight Mz. The desired MWD function (e.g., Mw/Mn or Mz/Mw) is the ratio of the corresponding M values. Measurement of M and MWD is well known in the art and is discussed in more detail in, for example, Slade, P. E. Ed., Polymer Molecular Weights Part II, Marcel Dekker, Inc., NY, (1975) 287-368; Rodriguez, F., Principles of Polymer Systems 3rd ed., Hemisphere Pub. Corp., NY, (1989) 155-160; U.S. Pat. No. 4,540,753; Verstrate et al., Macromolecules, vol. 21, (1988) 3360; and references cited therein.

The ethylene alpha-olefin diene polymer can have a molecular weight distribution Mw/Mn of greater than 3, or greater than 6, or greater than 10.

The relative degree of branching in the ethylene, alpha-olefin, diene polymer is determined using a branching index factor. Calculating the branching index factor requires a series of three laboratory measurements of polymer properties in solutions: (i) weight average molecular weight (Mw,LALLS) measured using a low angle laser light scattering (LALLS) technique; (ii) weight average molecular weight (Mw,DRI); and (iii) viscosity average molecular weight (Mv,DRI) using a differential refractive index detector (DRI); and (iv) intrinsic viscosity (IV) measured in decalin at 135° C.
The branching index (BI) is defined as:

$$BI = \frac{{M}_{v , br} {M}_{w , DRI}}{{M}_{w , LALLS} {M}_{v , DRI}} \qquad ( 1 )$$

where M_{v,br}=k(IV)^{1/a}, and ‘a’ is the Mark-Houwink constant (=0.759 for ethylene, alpha-olefin, diene monomer in decalin at 135° C.).

From equation (1), it follows that the branching index for a linear polymer is 1.0, and for branched polymers the extent of branching is defined relative to the linear polymer. Since at a constant Mn, (Mw)branch>(Mw)linear, BI for a branched polymers is less than 1.0, and a smaller BI value denotes a higher level of branching. It should be noted that this method indicates only the relative degree of branching and not a quantified amount of branching as would be determined using a direct measurement, such as by nuclear magnetic resonance (NMR). A detailed description of these measurements and calculations can be found in VerStrate, “Ethylene-Propylene Elastomers”, Encyclopedia of Polymer Science and Engineering, 6, 2nd edition, (1986).

The ethylene alpha-olefin diene polymer can have a branching index within the range having a lower limit of 0.05, or 0.1 and an upper limit of 0.3, or 0.4, or 0.5, or 0.7, or 0.8, or 0.9, or 1.0, or 1.5.

Ethylene Alpha-Olefin Polymer

Embodiments of the present invention include an ethylene alpha-olefin polymer. Suitable ethylene alpha-olefins are metallocene-catalyzed polymers of ethylene and an alpha-olefin comonomer, the alpha-olefin being a C₃-C₂₀ α-olefin and preferably a C₃-C₁₂ α-olefin. The α-olefin comonomer can be linear or branched, and two or more comonomers can be used, if desired. Examples of suitable alpha-olefin comonomers include propylene, linear C₄-C₁₂ α-olefins, and α-olefins having one or more C₁-C₃ alkyl branches. Specific examples include propylene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene, or 1-dodecene. Preferred comonomers include ethylene, 1-butene, 1-pentene, 3-methyl-1-butene, 1-hexene, 3-methyl-1-pentene, 4-methyl-1-pentene, 3,3-dimethyl-1-butene, 1-heptene, 1-hexene with a methyl substituent on any of C₃-C₅, 1-pentene with two methyl substituents in any stoichiometrically acceptable combination on C₃ or C₄, 3-ethyl-1-pentene, 1-octene, 1-pentene with a methyl substituent-on any of C₃ or C₄, 1-hexene with two methyl substituents in any stoichiometrically acceptable combination on C₃-C₅, 1-pentene with three methyl substituents in any stoichiometrically acceptable combination on C₃ or C₄, 1-hexene with an ethyl substituent on C₃ or C₄, 1-pentene with an ethyl substituent on C₃ and a methyl substituent in a stoichiometrically acceptable position on C₃ or C₄, 1-decene, 1-nonene, 1-nonene with a methyl substituent on any of C₃-C₉, 1-octene with two methyl substituents in any stoichiometrically acceptable combination on C₃-C₇, 1-heptene with three methyl substituents in any stoichiometrically acceptable combination on C₃-C₆, 1-octene with an ethyl substituent on any of C₃-C₇, 1-hexene with two ethyl substituents in any stoichiometrically acceptable combination on C₃ or C₄, and 1-dodecene. It should be appreciated that the list of comonomers above is merely exemplary, and is not intended to be limiting. A particularly preferred comonomer is octene.

The ethylene alpha-olefin polymer has one or more of the following characteristics:

(i) a molecular weight distribution Mw/Mn ranging from a lower limit of 1.5 or 1.8 to an upper limit of 40, or 20, or 10, or 5, or 3;

(ii) a Composition Distribution Breadth Index (CDBI) greater than 50% or greater than 60% or greater than 65%;

(iii) a Melt Index Ratio I₁₀/I₂ ranging from a lower limit of 5, or 7, or 8 to an upper limit of 9 or 10; and

(iv) a Melt Index Ratio I₂₁/I₂ ranging from a lower limit of 20, or 25, or 30 to an upper limit of 40, or 45, or 50.

Examples of suitable ethylene alpha-olefins include several of the polymers sold under the trademark EXACT™ and available from the ExxonMobil Chemical Co., Houston, Tex., as well as the ENGAGE™ polymers available from DuPont/Dow. Particular EXACT™ polymers include, but are not limited to EXACT™ 0201, EXACT™ 021HS, EXACT™ 0203, EXACT™ 8201, EXACT™ 8203, EXACT™ 210, and EXACT™ 8210. Typical ethylene alpha-olefins will have a density within the range having a lower limit of 0.86, or 0.87, or 0.88 g/cm³ and an upper limit of 0.91, or 0.92, or 0.94 g/cm³; and a melt index 12 of from a lower limit of 0.1, or 0.5, or 1.0 dg/min to an upper limit of 10, or 50, or 100 dg/min, consistent with the Melt Index Ratios described above.

The appropriate amount of alpha-olefin comonomer in the polymer can be readily determined by one skilled in the art, based on the desired density of the polymer. In one embodiment, the ethylene alpha-olefin polymer is present in the cable coating compound in an amount of from 10 to 90 percent by weight, based on the combined weight of the ethylene alpha-olefin diene elastomeric polymer and the ethylene alpha-olefin polymer. In another embodiment, the ethylene alpha-olefin polymer is present in the cable coating compound in an amount greater than 30 percent by weight, based on the combined weight of the ethylene alpha-olefin diene elastomeric polymer and the ethylene alpha-olefin polymer. In yet another embodiment, the ethylene alpha-olefin polymer is present in the cable coating compound in an amount of greater than 50 percent by weight, based on the combined weight of the ethylene alpha-olefin diene elastomeric polymer and the ethylene alpha-olefin polymer.

Cable Coating Compounds

Compounds can be formed using conventional mixing and extrusion techniques, as illustrated in the Examples herein.

In a particular embodiment, the power cable coating compound is a medium voltage cable compound which meets the Insulated Cable Engineers Association (ICEA) specifications for medium voltage compounds. These specifications include:
Electrical properties: dielectric constant of less than 4.0, and dissipation factor of less than 0.015 (ASTM D150-98);
Physical properties: tensile strength greater than 8.2 MPa, and elongation to break greater than 250% (ASTM D412-92);
Heat aging properties: greater than 80% tensile retention and greater than 80% elongation retention after aging for 14 days at 121° C. (ExxonMobil Chemical Co. test procedure); and
No gels: an absence of gelation regions in excess of 0.254 mm (ExxonMobil Chemical Co. test procedure).
   Extruded Compounds

In a particular embodiment, the compounds can be extruded at relatively high extrusion rates, while still maintaining a smooth extrusion surface.

The smoothness of the extrudates can be analyzed using a surface characterizing instrument, such as a Mitutoyo SURFTES™ SV-500. The instrument is equipped with a diamond stylus that moves over the surface of the extrudate under examination and records the surface irregularities over the length traveled by the stylus to create a surface profile, i.e., a two-dimensional cross-section of the surface of the extrudate. The surface profile includes a mean extrudate surface line, and positive and negative vertical deviations from the mean surface line. The surface roughness is quantified using a combination of two factors:
(1) Ra, the mean absolute vertical deviation from the mean extrudate surface line, in microns (μm); and
(2) Rt, the absolute vertical difference between the maximum positive vertical deviation from the mean extrudate surface line and the maximum negative vertical deviation from the mean extrudate surface line, in microns (μm).
   The Roughness Factor (R) is defined as:
   R=Ra+0.1Rt
   and incorporates both the Ra and Rt terms. Rt is given a lower weighting to adjust for its magnitude relative to Ra. R is dependent upon the extrusion rate and temperature.

Extruded compounds of the present invention can be characterized by the surface roughness factor R. Measured at an extrusion rate of 100 rpm and a temperature of 125° C., extruded compounds have a surface roughness factor R ranging from an upper limit of 20 μm or 15 μm or 10 μm to a lower limit of 5 μm or 3 μm or 1 μm or 0.

Certain features and advantages of embodiments of the invention are illustrated by the following, non-limiting examples.

### EXAMPLES

Compound Characterization

Cure characteristics, including ML, MH, Ts2, Tc90, cure state (MH-ML), and cure rate, were measured according to ASTM D2084-95, and are reported in dNm, dNm, min, min, dNm, dNm/min, respectively.

Hardness was measured according to ASTM D2240-91, and is reported in units of Shore A.

100%, 200%, and 300% Modulus were measured according to ASTM D412-92, and is reported in units of MPa.

Tensile strength was measured according to ASTM D412-92, and is reported in units of MPa.

Elongation was measured according to ASTM D412-92, and is reported in units of percent (%).

Compound processability assessments were conducted on a Haake RHEOCORD™ 90 extruder. The length to diameter (L/D) of the extruder screw for this extruder is 20/1, the compression ratio of the extruder screw is 2/1. A constricted die with a land length of 0.059″ (1.5 mm) and diameter of 0.069″. (1.75 mm) was selected for extrudate analysis. The extrusion temperature is maintained in the range of 110 to 125° C. Extrusion was performed over a range of screw speeds, varying from 25 to 100 rpm. Samples are obtained after the torque and the pressure drop equilibrated to a steady value at a constant screw speed.

The smoothness of the extrudates was analyzed using a Mitutoyo SURFTES™ SV-500 surface characterizing instrument, as described above, to obtain a surface roughness factor R.

The compounds as described below were mixed in a 1600 cm³ Banbury mixer using a volumetric fill factor of 75%. The total mixing time was seven minutes. The dump temperature of the compounds was typically 120° C. The compounds discharged from the Banbury mixer were sheeted out in a two roll mill. The peroxide curatives were added on the mill and ingested into the compound. The compounds were press cured for 20 minutes at 165° C.

Materials Used

VISTALON™ 1703, VISTALON™ 707, EXACT™ 8201, and EXACT™ 8203 are commercially available from ExxonMobil Chemical Co., Houston, Tex. Certain characteristics of the EP(D)M and ethylene-α-olefin polymers used in the Examples herein are shown in Tables 1 and 2, respectively.

TABLE 1
EP(D)M CHARACTERISTICS

| Polymer | VISTALON ™ 1703P | VISTALON ™ 707 |
|---|---|---|
| Diene | Vinyl norbornene | None |
| Mooney Viscosity | 25 | 22.5 |
| (1 + 4) @ 125° C. | | |
| Ethylene (wt %) | 77 | 71.8 |
| Diene (wt %) | 0.9 | 0 |
| Mn (g/mol) | 36000 | 7000 |
| Mw/Mn | 29.9 | >20 |
| Branching Index | 0.1 | 1.0 |

TABLE 2
ETHYLENE α-OLEFIN CHARACTERISTICS

| Polymer | EXACT ™ 8201 | EXACT ™ 8203 |
|---|---|---|
| Comonomer | 1-octene | 1-octene |
| Mooney Viscosity | 17 | 9.5 |
| (1 + 4) @ 125° C. | | |
| Melt Index (g/10 min) | 1.1 | 3 |
| Comonomer mol % | 8.9 | 8.9 |
| Density (g/cm³) | 0.882 | 0.882 |
| Crystallinity (%) | 19 | 19 |
| Mn (g/mol) | 45000 | not measured |
| Mw/Mn | 2.4 | 2.4 |
| Melt Index Ratio I₁₀/I₂ | 8.3 | not measured |
| Melt Index Ratio I₂₁/I₂ | 35 | not measured |

### Examples 1-3

Table 3 shows the cure characteristics and physical properties of compounds containing combinations of VISTALON™ 1703P and/or VISTALON™ 707 with an ethylene alpha-olefin polymer, EXACT™ 8201 or EXACT™ 8203.

TABLE 3
Cure Characteristics and Physical Properties

| | EXAMPLE | | |
|---|---|---|---|
| | 1 | 2 | 3 |
| EXACT ™ 8201 (phr) | 100 | 40 | 0 |
| EXACT ™ 8201 (phr) | 0 | 0 | 60 |
| VISTALON ™ 1703 (phr) | 0 | 60 | 20 |
| VISTALON ™ 707 (phr) | 0 | 0 | 20 |
| Dicup R (phr) | 2.6 | 2.6 | 2.6 |
| Agerite MA (phr) | 0.5 | 0.5 | 0.5 |
| Cure Characteristics | | | |
| ODR - 200° C., 3° Arc | | | |
| ML (dN · m) | 8 | 11 | 4 |
| MH (dN · m) | 101 | 74 | 73 |
| Ts2 (min) | 0.7 | 0.8 | 0.7 |
| T90 (min) | 2.1 | 2.2 | 2.1 |
| Cure Rate (dN · m/min) | 93 | 59 | 62 |
| Cure State (M_{H}-M_{L}) (dN · m) | 93 | 62 | 69 |
| Physical Properties | | | |
| cured 20 min, 165° C. | | | |
| Hardness (Shore A) | 92 | 86 | 88 |
| 100% Modulus (MPa) | 6.2 | 4.7 | 4.5 |
| 200% Modulus (MPa) | 7.1 | 6.4 | 5.3 |
| 300% Modulus (MPa) | 8.6 | — | 6.3 |
| Tensile Strength (MPa) | 18.2 | 6.9 | 17.9 |
| Elongation (%) | 420 | 215 | 515 |

Table 4 shows the processing characteristics of the compounds in Table 3. Examples 2 and 3 are smoother than Example 1 as indicated by surface roughness factors below 20 across the extruder rpm range. In the table below, “mf” is used to mean melt fracture.

TABLE 4
Processing Characteristics

| | EXAMPLE | | |
|---|---|---|---|
| | 1 | 2 | 3 |
| EXACT ™ 8201 (phr) | 100 | 40 | 0 |
| EXACT ™ 8201 (phr) | 0 | 0 | 60 |
| VISTALON ™ 1703 (phr) | 0 | 60 | 20 |
| VISTALON ™ 707 (phr) | 0 | 0 | 20 |
| Dicup R (phr) | 2.6 | 2.6 | 2.6 |
| Agerite MA (phr) | 0.5 | 0.5 | 0.5 |
| Processing Attributes | | | |
| Surface Roughness (Ra) | | | |
| (μm at rpm) | | | |
| 15 rpm | 17.8 | 6.9 | 4.0 |
| 25 rpm | mf | 3.5 | 5.4 |
| 35 rpm | mf | 5.7 | 5.9 |
| 45 rpm | mf | 6.7 | 8.1 |
| 55 rpm | mf | 6.7 | 8.0 |
| Surface Roughness (Rt) | | | |
| (μm at rpm) | | | |
| 15 rpm | 30 | 37 | 50 |
| 25 rpm | mf | 43 | 30 |
| 35 rpm | mf | 42 | 52 |
| 45 rpm | mf | 65 | 44 |
| 55 rpm | mf | 51 | 59 |
| Roughness Factor (R) | | | |
| (μm at rpm) | | | |
| 15 rpm | 30 | 11 | 9 |
| 25 rpm | mf | 8 | 8 |
| 35 rpm | mf | 10 | 11 |
| 45 rpm | mf | 13 | 13 |
| 55 rpm | mf | 12 | 14 |

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

Certain features of the present invention are described in terms of a set of numerical upper limits and a set of numerical lower limits. It should be appreciated that ranges from any lower limit to any upper limit are within the scope of the invention unless otherwise indicated.

All patents, test procedures, and other documents cited in this application are fully incorporated by reference to the extent such disclosure is not inconsistent with this application and for all jurisdictions in which such incorporation is permitted.

What is claimed is:

1. An electrically conductive device comprising:
(a) an electrically conductive portion; and
(b) an electrically insulating portion comprising an electrical insulation compound, the insulation compound comprising:
(i) at least 10 wt %, based on the total weight of the insulation compound, of an ethylene alpha-olefin diene elastomeric polymer; and
(ii) at least 10 wt %, based on the total weight of the insulation compound, of an ethylene alpha-olefin polymer having a Melt Index Ratio I₁₀/I₂ of at least 5;
wherein components (i) and (ii) make up at least 80 wt % of the total weight of the insulation compound, and
wherein the insulation compound contains 20 parts of filler or less per 100 parts of polymer.

2. The electrically conductive device of claim 1, wherein the insulation compound contains 15 parts of filler or less per 100 parts of polymer.

3. The electrically conductive device of claim 1, wherein the insulation compound contains 5 parts of filler or less per 100 parts of polymer.

4. The electrically conductive device of claim 1, wherein the insulation compound is substantially free of filler.

5. The electrically conductive device of claim 1, wherein the electrically insulating portion is an extruded compound having a surface roughness factor R of less than 20 μm.

6. The electrically conductive device of claim 3, wherein the electrically insulating portion is an extruded compound having a surface roughness factor R of less than 20 μm.

7. The electrically conductive device of claim 1, wherein the electrically insulating portion is an extruded compound having a surface roughness factor R of less than 15 μm.

8. The electrically conductive device of claim 3, wherein the electrically insulating portion is an extruded compound having a surface roughness factor R of less than 15 μm.

9. The electrically conductive device of claim 1, wherein the electrically insulating portion is an extruded compound having a surface roughness factor R of less than 10 μm.

10. The electrically conductive device of claim 3, wherein the electrically insulating portion is an extruded compound having a surface roughness factor R of less than 10 μm.

11. The electrically conductive device of claim 1, wherein the ethylene alpha-olefin polymer is present in the insulation compound in an amount of at least 30% by weight, based on the total weight of the insulation compound.

12. The electrically conductive device of claim 1, wherein the ethylene alpha-olefin polymer is present in the insulation compound in an amount of at least 50% by weight, based on the total weight of the insulation compound.

13. The electrically conductive device of claim 1, wherein the ethylene alpha-olefin polymer is present in the insulation compound in an amount of from to 90% by weight, based on the total weight of the insulation compound.

14. The electrically conductive device of claim 1, wherein the ethylene alpha-olefin polymer is a polymer of ethylene and octene.

15. The electrically conductive device of claim 1, wherein the ethylene alpha-olefin polymer is a polymer of ethylene and butene.

16. The electrically conductive device of claim 1, wherein the ethylene alpha-olefin polymer is a polymer of ethylene and hexene.

17. The electrically conductive device of claim 1, wherein the diene of the ethylene alpha-olefin diene elastomeric polymer is vinyl norbornene.

18. The electrically conductive device of claim 1, wherein the ethylene alpha-olefin diene elastomeric polymer has from 50 to 90 mol % ethylene-derived units and from 0.1 to 1.5 mol % diene-derived units.

19. The electrically conductive device of claim 1, wherein the device is a medium voltage power cable.

20. The electrically conductive device of claim 1, wherein the insulation compound additionally comprises an antioxidant in an amount of from 0.2 to 0.5 wt %, based on the total weight of the insulation compound.

21. An electrically conductive device comprising:
(a) an electrically conductive portion; and
(b) an electrically insulating portion comprising an electrical insulation compound, the insulation compound comprising:
(i) at least 10 wt %, based on the total weight of the insulation compound, of an ethylene alpha-olefin diene elastomeric polymer; and
(ii) at least 10 wt %, based on the total weight of the insulation compound, of an ethylene alpha-olefin polymer having a Melt Index Ratio I₁₀/I₂ of at least 5;
wherein components (i) and (ii) make up at least 80 wt % of the total weight of the insulation compound, and
wherein the insulation compound has a 28 day dissipation factor of less than 0.01.

22. The electrically conductive device of claim 21, wherein the electrically insulating portion is an extruded compound having a surface roughness factor R of less than 20 μm.

23. The electrically conductive device of claim 21, wherein the electrically insulating portion is an extruded compound having a surface roughness factor R of less than 15 μm.

24. The electrically conductive device of claim 21, wherein the electrically insulating portion is an extruded compound having a surface roughness factor R of less than 10 μm.

25. The electrically conductive device of claim 21, wherein the insulation compound is substantially free of filler.

26. The electrically conductive device of claim 24, wherein the insulation compound is substantially free of filler.

27. The electrically conductive device of claim 21, wherein the ethylene alpha-olefin polymer is present in the insulation compound in an amount of at least 30% by weight, based on the total weight of the insulation compound.

28. The electrically conductive device of claim 21, wherein the ethylene alpha-olefin polymer is present in the insulation compound in an amount of at least 50% by weight, based on the total weight of the insulation compound.

29. The electrically conductive device of claim 21, wherein the ethylene alpha-olefin polymer is present in the insulation compound in an amount of from 30 to 90% by weight, based on the total weight of the insulation compound.

30. The electrically conductive device of claim 21, wherein the ethylene alpha-olefin polymer is a polymer of ethylene and octene.

31. The electrically conductive device of claim 21, wherein the ethylene alpha-olefin polymer is a polymer of ethylene and butene.

32. The electrically conductive device of claim 21, wherein the ethylene alpha-olefin polymer is a polymer of ethylene and hexene.

33. The electrically conductive device of claim 21, wherein the diene of the ethylene alpha-olefin diene elastomeric polymer is vinyl norbornene.

34. The electrically conductive device of claim 21, wherein the ethylene alpha-olefin diene elastomeric polymer has from 50 to 90 mol % ethylene-derived units and from 0.1 to 1.5 mol % diene-derived units.

35. The electrically conductive device of claim 21, wherein the device is a medium voltage power cable.

36. The electrically conductive device of claim 26, wherein the device is a medium voltage power cable.

37. The electrically conductive device of claim 21, wherein the insulation compound additionally comprises an antioxidant in an amount of from 0.2 to 0.5 wt %, based on the total weight of the insulation compound.

38. The electrically conductive device of claim 35, wherein the insulation compound additionally comprises an antioxidant in an amount of from 0.2 to 0.5 wt %, based on the total weight of the insulation compound.
